(19) United States
(12) Patent Application Publication
(10) Pub. No.: US 2026/0001509 A1
(43) Pub. Date: Jan. 1, 2026

(54) DATA UPDATE METHOD AND SYSTEM

(71) Applicant: Honda Motor Co., Ltd., Tokyo (JP)

(72) Inventors: Keisuke Umehara, Tokyo (JP); Yasutaka Motoki, Tokyo (JP); Yuu Takemura, Tokyo (JP)

(21) Appl. No.: 19/246,639

(22) Filed: Jun. 23, 2025

(30) Foreign Application Priority Data
Jun. 28, 2024 (JP) 2024-105506

(51) Int. Cl. B60R 25/01; B60R 25/04; B60R 25/24; E05B 81/56; E05F 15/77; G06F 21/31

(52) U.S. Cl. CPC B60R 25/01; B60R 25/04; B60R 25/241; E05B 81/56; E05F 15/77; G06F 21/31; E05Y 2900/531; E05Y 2900/55

(57) ABSTRACT

A service providing apparatus includes a microprocessor and memory coupled to the microprocessor. The microprocessor performs: receiving operation instruction information transmitted from a user terminal and including an instruction of a remote operation for a vehicle; determining a validity period of the instruction, based on a type of the instruction included in the operation instruction information; and transmitting vehicle instruction information including the operation instruction information and validity period information to the in-vehicle terminal. The memory stores processing state information indicating a progress situation of processing performed by the in-vehicle terminal, based on the vehicle instruction information. The microprocessor further performs, unless processing result information indicating a result of the processing performed based on the vehicle instruction information from the in-vehicle terminal within the instruction validity period is received, updating the processing state information to information indicating that performing the processing is stopped.

### CROSS-REFERENCE TO RELATED APPLICATION

This application is based upon and claims the benefit of priority from Japanese Patent Application No. 2024-105506 filed on Jun. 28, 2024, the content of which is incorporated herein by reference.

### BACKGROUND

### Technical Field

The present invention relates to a service providing apparatus for providing a remote operation service for a vehicle.

### Related Art

In recent years, efforts to provide access to sustainable transportation systems in consideration of vulnerable people among traffic participants are becoming active. In order to achieve this, research and development for further improving traffic safety and convenience are focused on research and development regarding driving support technology. As this type of device, there has been conventionally known a device, upon receipt of update data encrypted with a predetermined encryption key, that decrypts the update data with a decryption key that has been distributed from a key management server, and that rewrites update target data using the decrypted update data (for example, see Japanese Patent No. 6663032).

However, in the method for encrypting data as with the device described in Japanese Patent No. 6663032, access to unencrypted data is possible, and thus there is room for improvement in terms of security.

### SUMMARY

An aspect of the present invention is a service providing apparatus including a microprocessor and a memory coupled to the microprocessor. The microprocessor is configured to perform: receiving operation instruction information transmitted from a user terminal and including an instruction of a remote operation for a vehicle on which an in-vehicle terminal is mounted; determining a validity period of the instruction of the remote operation, based on a type of the instruction included in the operation instruction information; and transmitting vehicle instruction information including the operation instruction information and validity period information indicating the validity period to the in-vehicle terminal. The memory is configured to store processing state information indicating a progress situation of processing performed by the in-vehicle terminal, based on the vehicle instruction information. The microprocessor is configured to further perform, unless processing result information indicating a result of the processing performed based on the vehicle instruction information from the in-vehicle terminal within the instruction validity period is received, updating the processing state information stored in the memory to information indicating that performing the processing is stopped.

### BRIEF DESCRIPTION OF DRAWINGS

The objects, features, and advantages of the present invention will become clearer from the following description of embodiments in relation to the attached drawings, in which:

FIG. 1 is a schematic view illustrating an example of a configuration of a remote operation system including an information processing apparatus according to an embodiment of the present invention;

FIG. 2 is a diagram for describing a remote operation of the vehicle via a user terminal;

FIG. 3 is a block diagram illustrating a main configuration of the service providing apparatus according to an embodiment of the present invention;

FIG. 4 is a diagram illustrating an example of validity period information;

FIG. 5 is a block diagram illustrating a main configuration of the in-vehicle terminal of FIG. 1;

FIG. 6A is a sequence diagram illustrating an example of an operation of the remote operation system of FIG. 1;

FIG. 6B is a sequence diagram illustrating another example of an operation of the remote operation system of FIG. 1;

FIG. 7A is a sequence diagram illustrating another example of an operation of the remote operation system of FIG. 1;

FIG. 7B is a sequence diagram illustrating another example of an operation of the remote operation system of FIG. 1;

FIG. 8 is a view illustrating an example of a configuration of a map update system including the information processing apparatus according to an embodiment of the present invention;

FIG. 9 is a sequence diagram illustrating the operation of the map update system of FIG. 8;

FIG. 10 is a diagram for describing an update timing of an access lock and an acquisition timing of the access lock; and

FIG. 11 is a diagram for describing a use start timing of the access lock.

### DETAILED DESCRIPTION OF THE INVENTION

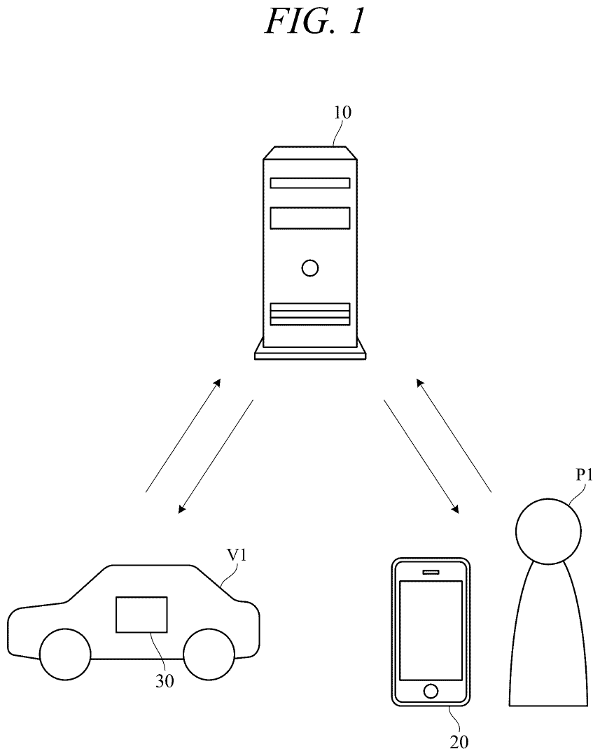

FIG. 1 is a schematic view illustrating an example of a configuration of a remote operation system 1 including an information processing apparatus (hereinafter, also referred to as a service providing apparatus) 10 according to an embodiment of the present invention. As illustrated in FIG. 1, the remote operation system 1 includes the service providing apparatus 10, a user terminal 20 such as a smartphone, and an in-vehicle terminal 30, and provides a service for remotely operating a vehicle V1 in accordance with a user operation that has been input into the user terminal 20. FIG. 1 illustrates one user terminal 20 used by a user P1 and one vehicle V1 including the in-vehicle terminal 30, but two or more user terminals may be connected to the service providing apparatus 10. In addition, two or more in-vehicle terminals may be connected to the service providing apparatus 10.

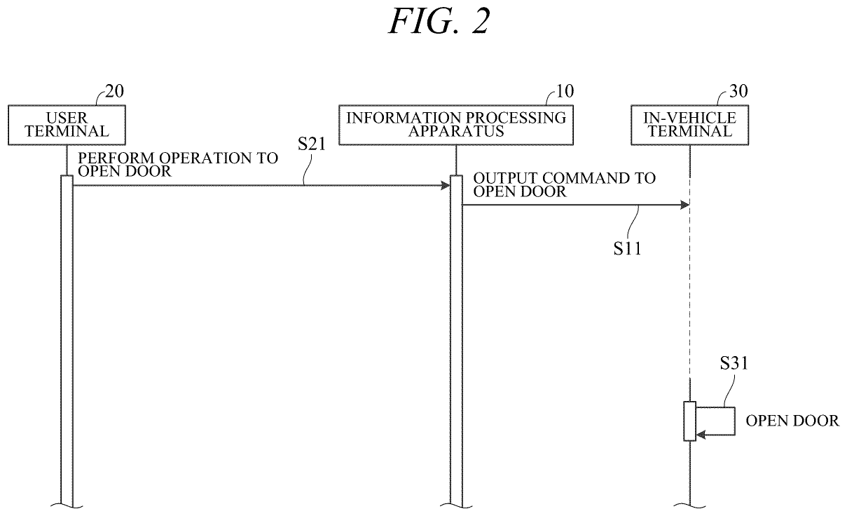

FIG. 2 is a diagram for describing a remote operation of the vehicle V1 via the user terminal 20. The user P1 is able to remotely operate the vehicle V1 on a dedicated application (hereinafter, referred to as an application) installed on the user terminal 20, which is used by the user P1. When the user P1 performs a remote operation for opening a door of the vehicle V1 on the application, information including a door open instruction and a vehicle ID, from which the vehicle V1 is identifiable (hereinafter, referred to as operation instruction information) is transmitted from the user terminal 20 to the service providing apparatus 10 (step S21). The operation instruction information also includes information indicating an object to be operated. The object to be operated is, for example, a driver's seat door or a rear door.

Upon receipt of the operation instruction information, the service providing apparatus 10 outputs a control command to the in-vehicle terminal 30, based on the operation instruction information (step S11). In a case where an instructed object indicated by the operation instruction information is the “driver's seat door” and an instructed content is “open”, the service providing apparatus 10 transmits a door open command designating the driver's seat door as the control command. The control command is transmitted to the in-vehicle terminal 30 of the vehicle V1, which is identified from the vehicle ID included in the operation instruction information.

Upon receipt of the door open command, the in-vehicle terminal 30 controls a door actuator corresponding to the driver's seat door designated by the door open command to open the driver's seat door (step S31).

When a communication failure between the service providing apparatus 10 and the in-vehicle terminal 30 or a malfunction of a system (ECU or the like) of the in-vehicle terminal 30 occurs, a control command from the service providing apparatus 10 may be stagnated. In this case, as illustrated in FIG. 2, there is a possibility that processing in accordance with the command (processing of step S31) might be delayed and performed after the malfunction or the like is resolved. In FIG. 2, a period during which the communication failure is occurring between the service providing apparatus 10 and the in-vehicle terminal 30 is schematically represented by a broken line. In addition, in a case where the failure or the like is not resolved, there is a possibility that the processing in accordance with the command might not be performed. Hence, in order to solve such a problem, in the present embodiment, the service providing apparatus 10 is configured as follows.

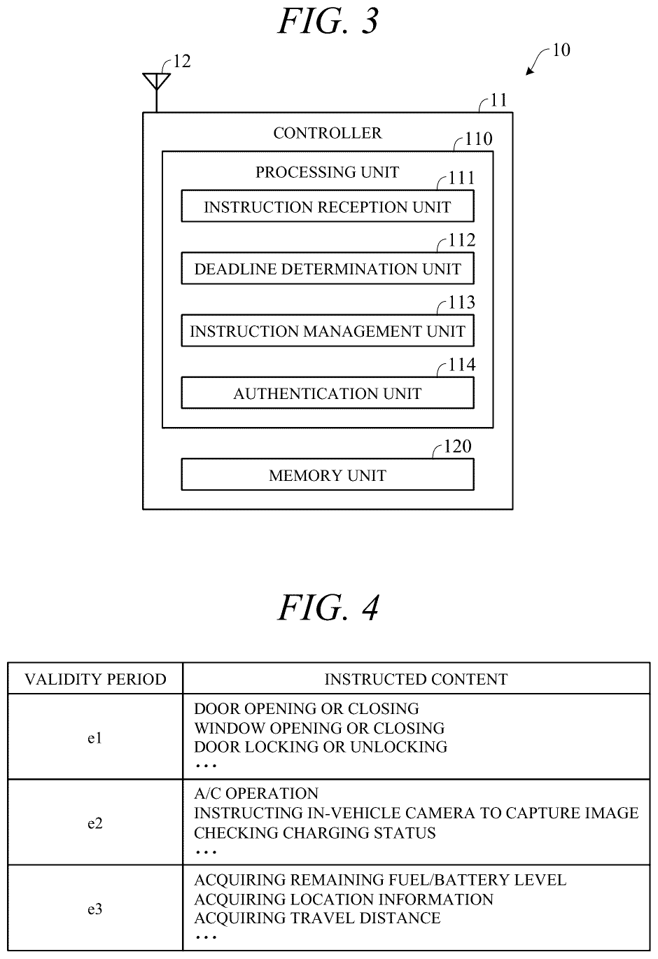

FIG. 3 is a block diagram illustrating a main configuration of the service providing apparatus 10 according to an embodiment of the present invention. The service providing apparatus 10 is configured with, for example, a server apparatus. Note that the service providing apparatus 10 may be configured by using a virtual server function on the cloud, or may be configured to be distributed to a plurality of apparatuses. As illustrated in FIG. 3, the service providing apparatus 10 includes a controller 11, and a communication unit 12. The communication unit 12 communicates with various servers and the like through a network including a wireless communication network represented by the Internet network, a mobile telephone network, and the like, and transmits and receives necessary information periodically or at any timing. The network includes not only a public wireless communication network but also a closed communication network provided for every predetermined management region, for example, a wireless LAN, Wi-Fi (registered trademark), or the like.

The controller 11 is configured with a computer including a processing unit 110 such as a microprocessor (CPU), a storage unit 120 such as a ROM and a RAM, and another peripheral circuit, not illustrated, such as an I/O interface.

The storage unit 120 stores programs for various types of control, information such as threshold values for use in the programs, validity period information and processing state information (hereinafter, also referred to as status information) to be described later, and the like.

The processing unit 110 includes, as functional configurations, an instruction reception unit 111, a deadline determination unit (hereinafter, simply referred to as a determination unit) 112, an instruction management unit 113, and an authentication unit 114.

The instruction reception unit 111 receives, via the communication unit 12, the operation instruction information, which has been transmitted from the user terminal 20, and which includes an instruction of a remote operation for the vehicle V1 on which the in-vehicle terminal 30 is mounted.

The determination unit 112 determines a validity period of the remote operation instruction, based on the type of a remote operation instruction included in the operation instruction information that has been received by the instruction reception unit 111. Specifically, the determination unit 112 reads, from the storage unit 120, information indicating the validity period (hereinafter, referred to as validity period information) corresponding to the remote operation instruction, based on the type of the remote operation instruction included in the operation instruction information. The storage unit 120 stores the validity period information for every type of the remote operation instruction. The remote operation instruction includes an opening or closing instruction of a door (the driver's seat door, a passenger's seat door, a rear door, or the like) or a window (a front window, a rear window, or the like) of the vehicle V1, and an ON/OFF instruction of an air conditioner of the vehicle V1. In addition, the remote operation instruction includes a lock or unlock instruction to lock or unlock a door of the vehicle V1. Further, the remote operation instruction includes a start or stop instruction for the engine of the vehicle V1. Furthermore, the remote operation instruction includes an instruction to acquire information such as a state of charge (during charging or not during charging), a traveling position, a traveling distance, and a remaining battery amount of the vehicle V1.

FIG. 4 is a diagram illustrating an example of the validity period information stored in the storage unit 120. Validity periods e1, e2, and e3 (e1<e2<e3) of the remote operation instruction are calculated, based on the length of a delay time permitted for the remote operation instruction. With regard to the door opening or closing instruction or the window opening or closing instruction, if processing based on such an instruction (for opening or closing a door or opening or closing a window) is performed at an unintended timing such as while the vehicle V1 is traveling, it will not be desirable. More specifically, while the vehicle V1 is stopped, if the processing based on the door opening or closing instruction or the window opening or closing instruction received by the instruction reception unit 111 is delayed due to some circumstances and is performed after the vehicle V1 starts traveling, it will not be desirable. For this reason, as in the example of FIG. 4, the validity period e1, which is shorter than the other remote operation instructions, is set for those remote operation instructions. On the other hand, a strict real-time performance is not necessitated for an instruction to acquire information such as the traveling position, the traveling distance, or the remaining battery amount of the vehicle V1. Therefore, as in the example of FIG. 4, the validity period e3 for those remote operation instructions is set to be longer than the validity periods of the other remote operation instructions. Note that the validity period of each remote operation instruction illustrated in FIG. 4 is an example, and a validity period different from the values illustrated in FIG. 4 may be set for each remote operation instruction.

The instruction management unit 113 generates information (hereinafter, referred to as vehicle instruction information) including the operation instruction information that has been received by the instruction reception unit 111, specifically, a control command based on the operation instruction information, and the validity period information indicating the validity period that has been determined by the determination unit 112. The instruction management unit 113 transmits the vehicle instruction information that has been generated to the in-vehicle terminal 30 of the vehicle V1 via the communication unit 12.

In addition, the instruction management unit 113 stores, in the storage unit 120, the status information indicating a progress situation (“processing being performed”, “processing completed”, “processing failed”, “processing stopped”, or the like) of the processing performed by the in-vehicle terminal 30, based on the vehicle instruction information. More specifically, when the instruction reception unit 111 receives the operation instruction information from the user terminal 20, the instruction management unit 113 updates the status information to information indicating that the processing is being performed (“processing being performed”). In addition, after the instruction management unit 113 transmits the vehicle instruction information including the operation instruction information to the in-vehicle terminal 30, upon receipt of processing result information (“processing completed” or “processing failed”) indicating a result of the processing that has been performed, based on the vehicle instruction information from the in-vehicle terminal 30 within the validity period that has been determined by the determination unit 112, the instruction management unit 113 updates the status information with the processing result information. On the other hand, in a case where the instruction management unit 113 does not receive the processing result information from the in-vehicle terminal 30 within the validity period, the instruction management unit 113 updates the status information with information indicating that execution of the processing is stopped (“processing stopped”).

The authentication unit 114 creates (generates) an access lock (hereinafter, also referred to as an access key) and an access key (hereinafter, also referred to as an access token) that is capable of unlocking the access lock in every predetermined period, and transmits the created access key to the in-vehicle terminal 30. Upon receipt of an access request from the in-vehicle terminal 30 via the communication unit 12, the authentication unit 114 collates the access lock with the access key accompanied by the access request. As a collation result, in a case where the access lock can be unlocked with the access key, the authentication unit 114 approves the access request from the in-vehicle terminal 30.

Note that the determination unit 112 determines the validity period for the remote operation instruction (hereinafter, referred to as an instruction validity period, in some cases) not to exceed the above predetermined period, that is, the validity period set for the access lock (hereinafter, referred to as a key validity period, in some cases). More specifically, when the expiration of the instruction validity period that has been determined, based on the type of the remote operation instruction, exceeds the expiration of the key validity period, the determination unit 112 may shorten the instruction validity period by a length of time corresponding to an excess of the instruction validity period. Note that instead of the determination unit 112 adjusting the length of time of the instruction validity period, the authentication unit 114 may adjust the length of time of the key validity period. Specifically, the next update of the access lock may be delayed to the expiration of the instruction validity period.

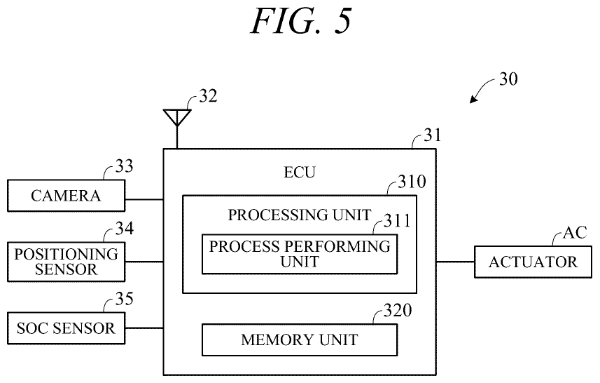

FIG. 5 is a block diagram illustrating a main configuration of the in-vehicle terminal 30 in FIG. 1. The in-vehicle terminal 30 includes an electronic control unit (ECU) 31, a communication unit 32, a camera 33, a positioning sensor 34, a state of charge (SOC) sensor 35, and an actuator AC. Note that the communication unit 32 is similar to the communication unit 12 in FIG. 3, and thus its description will be omitted.

The camera 33 includes an imaging element such as a CCD or a CMOS, and captures images of the surroundings (forward, rearward, and lateral sides) of the host vehicle. The positioning sensor 34 is a GPS sensor, receives a positioning signal transmitted from a GPS satellite, and detects an absolute position (such as latitude and longitude) of the vehicle V1. Note that the positioning sensor 34 may be a sensor other than the GPS sensor. The SOC sensor 35 detects a remaining charge amount of a battery (not illustrated) mounted on the vehicle VI as a secondary battery such as a lithium ion battery.

The actuator AC includes a door actuator that automatically opens or closes a door (the driver's seat door, a rear door, or the like) of the vehicle V1 and a power window actuator that automatically opens or closes a window (a front window, a rear window, or the like) of the vehicle V1. The actuator AC also includes a door lock actuator that unlocks or locks a door of the vehicle V1. Furthermore, the actuator AC includes various actuators for controlling traveling of the host vehicle.

As illustrated in FIG. 5, the ECU 31 is configured with a computer including a processing unit 310 such as a CPU, a storage unit 320 such as a ROM and a RAM, and another peripheral circuit, not illustrated, such as an I/O interface. The storage unit 320 stores programs for various types of control, information such as thresholds for use in the programs, map information to be described later, and the like. By executing a program stored beforehand in the storage unit 320, the processing unit 310 functions as a process performing unit 311.

The process performing unit 311 establishes communication with the service providing apparatus 10 by using the access key that has been distributed from the authentication unit 114 of the service providing apparatus 10. This enables secure data transmission and reception between the process performing unit 311 and the service providing apparatus 10. Upon receipt of the vehicle instruction information via the communication unit 12, the process performing unit 311 acquires the operation instruction information included in the vehicle instruction information, and performs processing in accordance with the remote operation instruction included in the operation instruction information.

In a case where the remote operation instruction is an instruction to acquire information such as the traveling position, the traveling distance, or the remaining battery amount of the vehicle V1, the process performing unit 311 transmits a sensor value of the positioning sensor 34 or the SOC sensor 35 together with a vehicle ID of the vehicle V1 to the service providing apparatus 10 via the communication unit 12. The service providing apparatus 10 transmits the sensor value that has been received to the user terminal 20. In addition, in a case where the remote operation instruction is an instruction to open or close a door or a window, the process performing unit 311 controls the actuator AC to open or close the door or the window of the vehicle V1.

Further, in a case where the remote operation instruction is an imaging instruction for the camera, the process performing unit 311 outputs an imaging signal to the camera 33. Then, the process performing unit 311 transmits a captured image that has been obtained by the camera 33 to the service providing apparatus 10. The service providing apparatus 10 transmits the captured image that has been received to the user terminal 20. Furthermore, in a case where the remote operation instruction is an ON/OFF instruction for the air conditioner, the process performing unit 311 outputs an ON/OFF signal to an air conditioner device, not illustrated, of the vehicle V1.

Note that in a case where the in-vehicle terminal 30 includes a detector other than the camera, for example, a radar or a LiDAR, the process performing unit 311 may transmit detection data of these detectors to the service providing apparatus 10 in accordance with a remote operation instruction. In addition, the process performing unit 311 may transmit a sensor value of another sensor such as a vehicle speed sensor to the service providing apparatus 10 in accordance with the remote operation instruction.

Further, in a case where the vehicle V1 has an automatic driving function or a driving support function, the process performing unit 311 may process a target route on a road to a destination that has been input by the driver, based on the current position of the vehicle V1 that has been measured by the positioning sensor 34 and the map information stored in the storage unit 320, and may control the actuator AC so that the vehicle V1 travels along the target route.

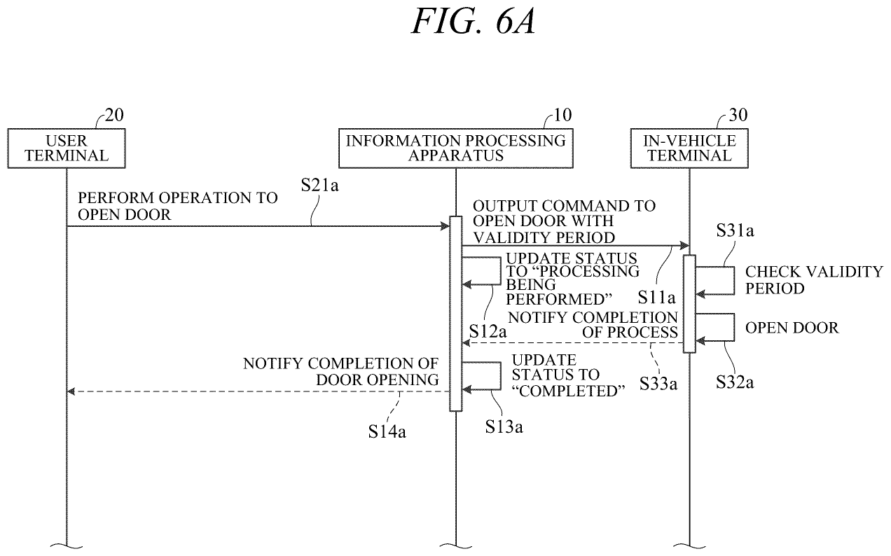

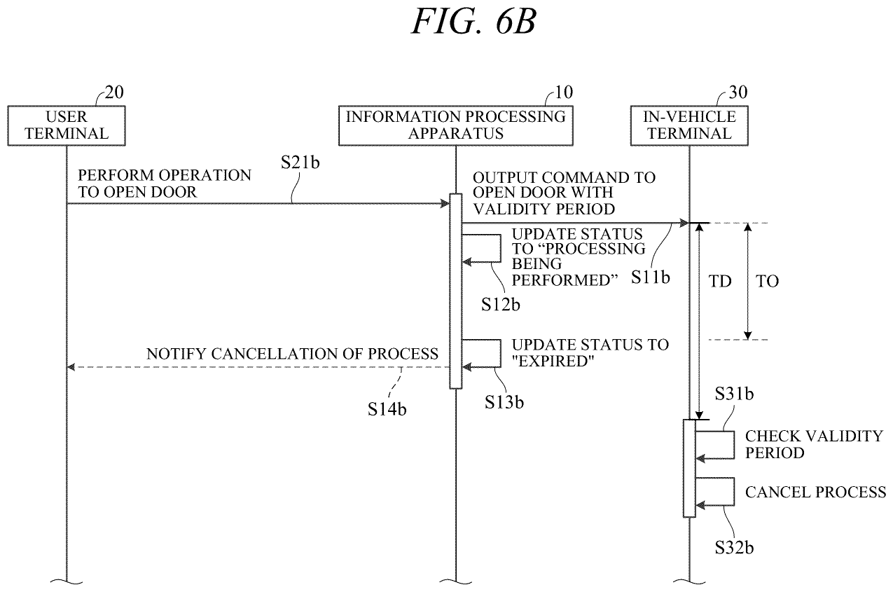

FIGS. 6A and 6B are sequence diagrams illustrating the operation of the remote operation system 1. Similarly to FIG. 2, FIG. 6A illustrates an example of the operation when the user P1 performs a remote operation for a door of the vehicle V1. When the user P1 performs the remote operation for opening the door of the vehicle V1 on the application, operation instruction information including a door open instruction and the vehicle V1 is transmitted from the user terminal 20 to the service providing apparatus 10 (step S21a).

When receiving the operation instruction information, the service providing apparatus 10 outputs a control command to the in-vehicle terminal 30, based on the operation instruction information (step S11a). Then, the service providing apparatus 10 transmits vehicle instruction information including a control command (a door open command) and validity period information to the in-vehicle terminal 30. The validity period information includes an output time (hereinafter, referred to as a command output time) of the control command and the validity period (e1, e2, or e3 in FIG. 4). Note that the validity period information may include other information such as time and date of the validity period. The service providing apparatus 10 updates the status information to “processing being performed” (step S12a). The service providing apparatus 10 manages the status information together with information from which the control command is uniquely identifiable (hereinafter, referred to as a command ID). Specifically, the service providing apparatus 10 stores the status information and the command ID in the storage unit 120 in association with each other.

When receiving the vehicle instruction information (the control command and the validity period information), the in-vehicle terminal 30 first determines whether the control command is valid, based on the validity period information (step S31a). Specifically, the in-vehicle terminal 30 determines whether the elapsed time from the command output time exceeds the validity period. In a case where the elapsed time does not exceed the validity period, the in-vehicle terminal 30 performs processing in accordance with the control command (step S32a). More specifically, the in-vehicle terminal 30 controls the door actuator, based on the control command (the door open command) to open the door, which is an object to be operated. Then, the in-vehicle terminal 30 transmits processing result information indicating completion of the processing to the service providing apparatus 10 (step S33a).

When receiving a completion notification of the processing, the service providing apparatus 10 updates the status information stored in the storage unit 120 to “processing completed” (step S13a), and notifies the user terminal 20 of the completion of the remote operation (step S14a).

FIG. 6B illustrates an example of the operation of the remote operation system 1 when the in-vehicle terminal 30 receives the control command after a time TD elapses from the command output time. Note that steps S11b, S12b, and S21b in FIG. 6B are similar to steps S11a, S12ba, and S21a in FIG. 6A, and thus these descriptions will be omitted.

When receiving the control command, the in-vehicle terminal 30 determines whether the control command is valid, based on the validity period information accompanied by the control command (step S31b). As illustrated in FIG. 6B, when the elapsed time TD from the command output time exceeds a validity period TO due to a system failure or the like, the in-vehicle terminal 30 cancels the processing based on the control command without performing the processing (step S32b).

Even though the elapsed time from the command output time exceeds the validity period TO, in a case where the completion notification of the processing from the in-vehicle terminal 30 is not received, the service providing apparatus 10 updates the status information to “process stopped” (step S13b). Then, the service providing apparatus 10 notifies the user terminal 20 of cancellation of the processing (step S14b).

As illustrated in FIGS. 6A and 6B, the in-vehicle terminal 30 determines whether to perform processing in accordance with the control command, based on the validity period information accompanied by the control command. Thus, it becomes possible to suppress the control by the vehicle in accordance with the remote operation conducted at an unintended timing.

According to embodiments of the present invention, the following operation and effect are achievable.
(1) The service providing apparatus 10 includes: the instruction reception unit 111, which receives operation instruction information that has been transmitted from the user terminal 20 and that includes an instruction of a remote operation for the vehicle V1 on which the in-vehicle terminal 30 is mounted; the determination unit 112, which determines a validity period of the instruction (an instruction validity period) of the remote operation, based on the type of the instruction of the remote operation included in the operation instruction information; the instruction management unit 113, which transmits vehicle instruction information including the operation instruction information and validity period information indicating the instruction validity period to the in-vehicle terminal of the vehicle V1; and the storage unit 120, which stores processing state information indicating a progress situation of processing performed by the in-vehicle terminal 30, based on the vehicle instruction information. Unless the instruction management unit 113 receives processing result information indicating a result of the processing performed, based on the vehicle instruction information from the in-vehicle terminal 30 within the instruction validity period, the instruction management unit 113 updates the processing state information stored in the storage unit 120 to information indicating that performing the processing is stopped. Thus, it becomes possible to suppress the control by the vehicle in accordance with the remote operation conducted at an unintended timing. As a result, it becomes possible to provide the remote operation service that the user is able to use reliably.
(2) The service providing apparatus 10 further includes the authentication unit 114, which generates an access lock to which a validity period (a key validity period) is set and an access key capable of unlocking the access lock, the access lock and the access key being used in an authentication process of the in-vehicle terminal 30. The determination unit 112 determines the instruction validity period not to exceed the key validity period. Accordingly, the validity period of the instruction of the remote operation is set within a period while the in-vehicle terminal 30 is authorized to access the service providing apparatus 10, so that the service providing apparatus 10 can reliably receive the processing result information from the in-vehicle terminal 30. As a result, it becomes possible to reliably notify the user of the processing result of the remote operation.
(3) When the instruction reception unit 111 receives the operation instruction information including the instruction of the remote operation, the instruction management unit 113 updates the processing state information to information indicating that the processing is being performed (“processing being performed”). The instruction management unit 113 transmits the vehicle instruction information including the operation instruction information that has been received to the in-vehicle terminal 30. After transmitting the vehicle instruction information to the in-vehicle terminal 30, upon receipt of the processing result information from the in-vehicle terminal 30 within the instruction validity period, the instruction management unit 113 updates the processing state information with the processing result information (“processing completed” or “processing failed”), whereas when not receiving the processing result information from the in-vehicle terminal 30 within the instruction validity period, the instruction management unit 113 updates the processing state information with information indicating that performing the processing is stopped (“processing stopped”). Accordingly, the status of performing the remote operation for which the validity period is set can be managed appropriately.
(4) The storage unit 120 stores the validity period information (FIG. 4) corresponding to each of a plurality of remote operation instructions of different types. The determination unit 112 reads the validity period information corresponding to the instruction of the remote operation from the storage unit 120, based on the type of the instruction of the remote operation included in the operation instruction information that has been received by the instruction reception unit 111. The instruction management unit 113 transmits, to the in-vehicle terminal 30, the vehicle instruction information including the operation instruction information and the validity period information that has been read from the storage unit 120 by the determination unit 112. Accordingly, the user is able to use the remote operation service reliably regardless of the type of the instruction of the remote operation.

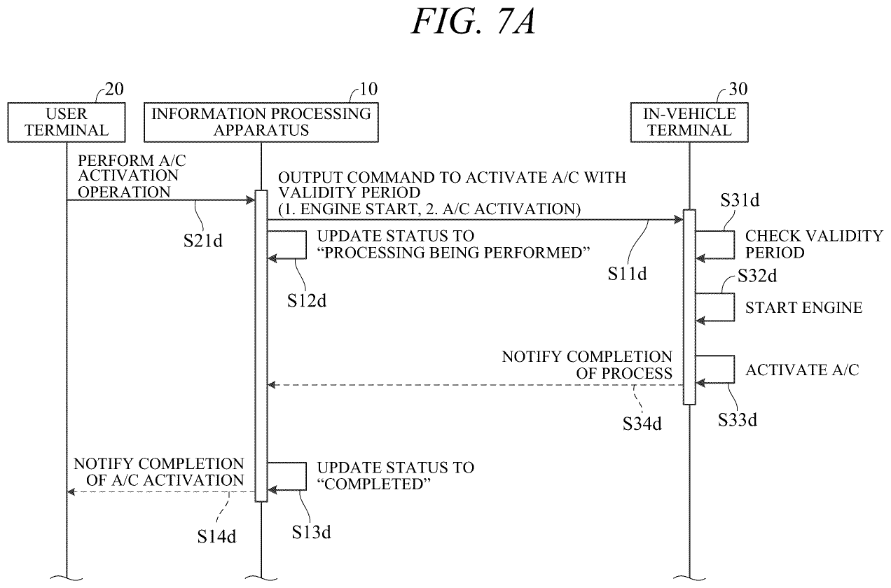

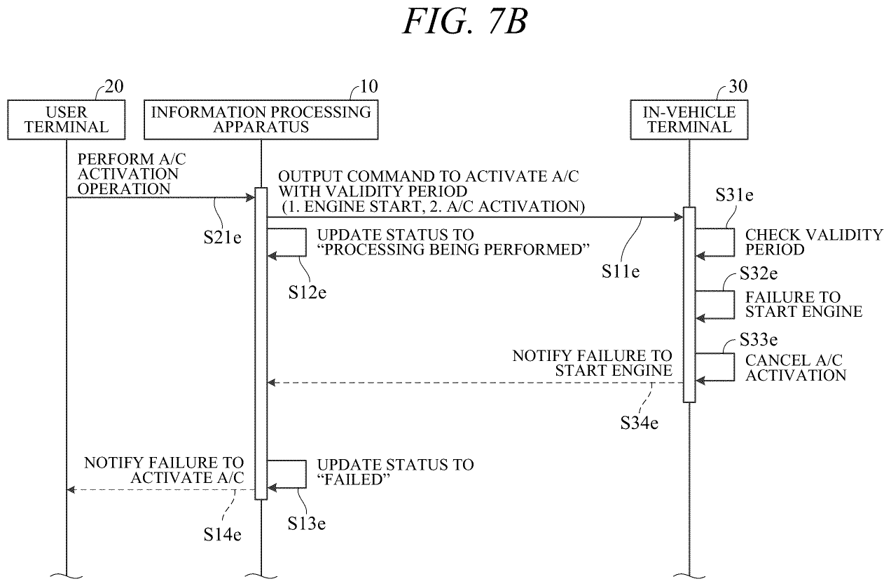

Note that in the above embodiment, the description has been made with regard to an example of a case where the operation instruction information that has been received by the instruction reception unit 111 includes a single remote operation instruction (the door open instruction). However, the operation instruction information may include a series of remote operation instructions in which the performing order is defined. FIGS. 7A and 7B are sequence diagrams illustrating another example of the operation of the remote operation system 1 of FIG. 1. FIG. 7A illustrates an example of the operation of the service providing apparatus 10 when the user P1 performs a remote operation for activating the air conditioner (A/C) of the vehicle V1 on the application.

When the user P1 performs, on the application, a remote operation for activating the A/C of the vehicle V1 in an engine stop state, operation instruction information including an engine (ENG) start instruction and an A/C activation instruction is transmitted from the user terminal 20 to the service providing apparatus 10 as illustrated in FIG. 7A (step S21d). The operation instruction information includes information that defines the performing order of the ENG start instruction and the A/C activation instruction. Note that steps S13d and S14d in FIG. 7A are similar to steps S13a and S14a in FIG. 6A, and thus these descriptions will be omitted.

When receiving the operation instruction information including a series of remote operation instructions (the ENG start instruction and the A/C activation instruction), the service providing apparatus 10 generates vehicle instruction information including a series of control instructions (the ENG start instruction and the A/C activation instruction) that define the performing order, based on the operation instruction information. In this situation, the service providing apparatus 10 reads the validity period information corresponding to the series of remote operation instructions from the storage unit 120, and includes the validity period information in the vehicle instruction information. The service providing apparatus 10 transmits the vehicle instruction information that has been generated to the in-vehicle terminal 30 (step S11d). In this manner, the vehicle instruction information including the series of control commands that define the performing order is transmitted to the in-vehicle terminal 30 so that the in-vehicle terminal 30 can manage the performing order of the processing. This eliminates the need to manage the performing order by the service providing apparatus 10. As a result, the processing load on the service providing apparatus 10 can be reduced.

When receiving the vehicle instruction information, the in-vehicle terminal 30 first determines whether a series of control commands is valid, based on the validity period information (step S31d). In a case where the series of control commands is valid, the in-vehicle terminal 30 performs processing in accordance with each control command corresponding to the defined performing order. Specifically, first, the in-vehicle terminal 30 outputs a start signal to an engine start device (not illustrated) of the vehicle V1 in accordance with the ENG start command (step S32d). When receiving a notification of a start success from the engine start device, the in-vehicle terminal 30 outputs an ON signal to the air conditioner device of the vehicle V1 (step S33d). When receiving a notification of an activation success from the air conditioner device, the in-vehicle terminal 30 transmits processing result information indicating completion of the processing to the service providing apparatus 10 (step S34d).

FIG. 7B illustrates another example of the operation of the service providing apparatus 10 when the user P1 performs, on the application, a remote operation for activating the air conditioner (A/C) of the vehicle V1. Note that steps S11e, S12e, S21e, and S31e in FIG. 7B are similar to steps S11d, S12d, S21d, and S31d in FIG. 7A, and thus these descriptions will be omitted.

After outputting the start signal to the engine start device of the vehicle V1 in accordance with the ENG start command, when receiving a notification of a start failure from the engine start device (step S32e), the in-vehicle terminal 30 cancels the processing without performing the processing in accordance with its subsequent A/C start command (step S33e). In addition, the in-vehicle terminal 30 transmits processing result information indicating that the processing (ENG start) has failed to the service providing apparatus 10 (step S34e).

Note that after receiving the notification of the start failure from the engine start device, the in-vehicle terminal 30 may transmit processing result information indicating that the processing (the ENG start) has failed to the service providing apparatus 10. That is, after step S32e, the processing may proceed to step S34e. Then, the service providing apparatus 10, which has received the notification of the processing failure from the in-vehicle terminal 30, may transmit a cancel command to the in-vehicle terminal 30, and the in-vehicle terminal 30 may cancel the processing in accordance with its subsequent control command, in response to such a cancel command.

When receiving the notification of the processing failure from the in-vehicle terminal 30, the service providing apparatus 10 updates the status information stored in the storage unit 120 to “processing failed” (step S13e), and notifies the user terminal 20 of the failure of the remote operation (step S14e).

In the above embodiment, incidentally, the service providing apparatus 10 creates the access lock and the access key capable of unlocking the access lock, and distributes the access key to the in-vehicle terminal 30. Then, when receiving the access request from the in-vehicle terminal 30, the service providing apparatus 10 collates the access key accompanied by the access request with the access lock, and determines whether to approve the access request from the in-vehicle terminal 30. However, such an authentication process may be performed between the in-vehicle terminal 30 and an external device. According to such a configuration, it becomes possible to provide a service such as data distribution from the external device to the vehicle V1 without intervention of the service providing apparatus 10. Therefore, the authentication unit 114 of the service providing apparatus 10 may operate as follows.

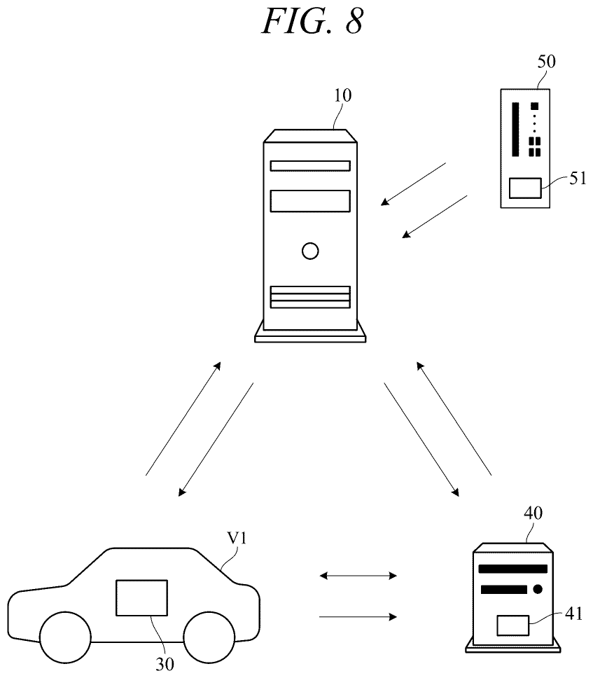

FIG. 8 is a view illustrating an example of a configuration of a map update system 2 including the service providing apparatus 10. As illustrated in FIG. 8, the map update system 2 includes the service providing apparatus 10, the in-vehicle terminal 30, a map server 40, and a vehicle authentication server 50. The map update system 2 distributes map information from the map server 40 to the in-vehicle terminal 30 of the vehicle V1, and provides a service for updating the map information (hereinafter, referred to as a map update service) of the in-vehicle terminal 30. The map server 40 and the vehicle authentication server 50 are configured with, for example, a server apparatus. The map server 40 and the vehicle authentication server 50 each include a controller (controllers 41 and 51 in FIG. 8) configured to include a computer including a processing unit such as a CPU (microprocessor), a storage unit such as a ROM and a RAM, and another peripheral circuit, not illustrated, such as an I/O interface. Note that the map server 40 and the vehicle authentication server 50 may each be configured using a virtual server function on a cloud, or may each be configured to be distributed to a plurality of devices.

Note that the map update system 2 includes a plurality of vehicles (in-vehicle terminals), and the map server 40 distributes the map information to the in-vehicle terminals of the respective vehicles. However, only one vehicle V1 (the in-vehicle terminal 30) is illustrated in FIG. 8 in order to simplify the description.

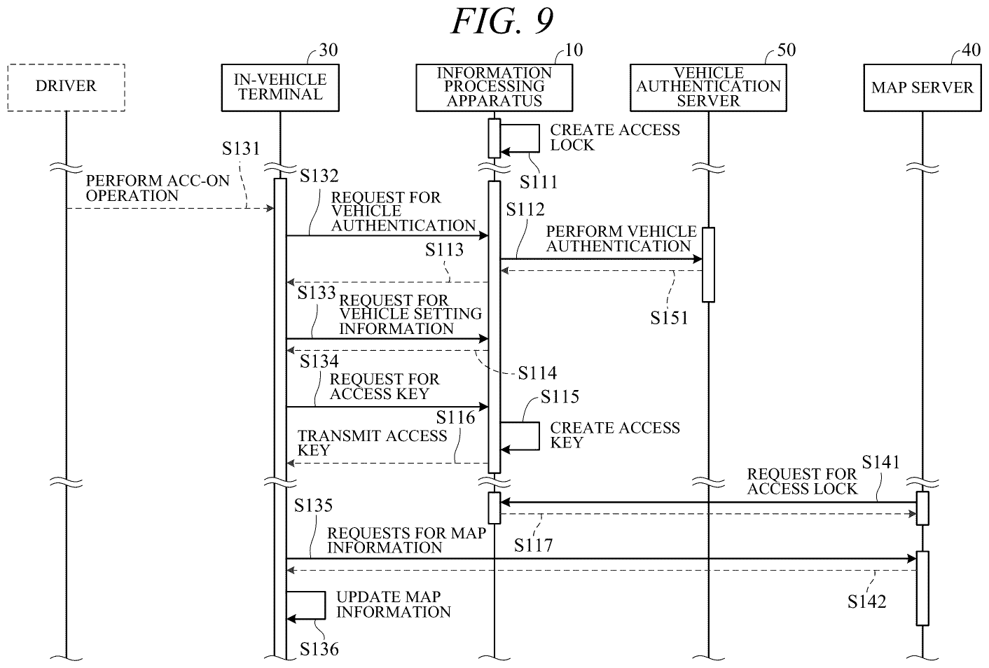

FIG. 9 is a sequence diagram illustrating the operation of the map update system 2. The authentication unit 114 of the service providing apparatus 10 creates an access lock (hereinafter, simply referred to as a lock) K (step S111). The authentication unit 114 creates the access lock K in every predetermined period PD. That is, the access lock K is updated in every predetermined period PD.

The access lock K and an access key (hereinafter, simply referred to as a key, in some cases) T to be described later are used in an authentication process between the in-vehicle terminal 30 and the map server 40. More specifically, the in-vehicle terminal 30 accesses the map server 40 using the access key T, which has been distributed from the service providing apparatus 10. The map server 40 authenticates the in-vehicle terminal 30 using the access lock K, which has been distributed from the service providing apparatus 10. Specifically, the map server 40 accepts only an access from the in-vehicle terminal 30 using the access key T corresponding to the access lock K.

When receiving an accessory-on (ACC-ON) operation by the user (the driver) of the vehicle VI on an operation unit, not illustrated (step S131), the in-vehicle terminal 30 transmits a request command for vehicle authentication to the service providing apparatus (step S132).

When receiving the request command for the vehicle authentication, the authentication unit 114 transmits the vehicle ID of the vehicle V1 accompanied by the request command to the vehicle authentication server 50 (step S112). The vehicle to which a map arrangement service is to be provided is a vehicle (hereinafter, referred to as a registered vehicle) in which necessary information (such as the vehicle ID) is registered beforehand in a business enterprise that manages the service providing apparatus 10. The storage unit (not illustrated) of the vehicle authentication server 50 stores information (hereinafter, referred to as an authentication database (DB)) in which the vehicle ID of the registered vehicle is associated with an authentication token. The vehicle authentication server 50, specifically, the controller 51 included in the vehicle authentication server 50 reads the authentication token corresponding to the received vehicle ID from the authentication DB, and transmits the authentication token to the service providing apparatus 10 (step S151). Note that in a case where the authentication token corresponding to the vehicle ID that has been received from the service providing apparatus 10 is not registered in the authentication DB, that is, in a case where the vehicle identified by the vehicle ID is not a registered vehicle, the vehicle authentication server 50 transmits information indicating an authentication error to the service providing apparatus 10 instead of the authentication token.

When receiving the authentication token from the vehicle authentication server 50, the service providing apparatus 10 transmits the authentication token to the in-vehicle terminal 30 (step S113). By using the authentication token that has been issued as described above, the in-vehicle terminal 30 is capable of accessing the service providing apparatus 10. In a case where the service providing apparatus 10 receives the information indicating the authentication error from the vehicle authentication server 50, access of the in-vehicle terminal 30 to the service providing apparatus 10 is restricted.

When the authentication token is issued, the in-vehicle terminal 30 requests the service providing apparatus 10 for vehicle setting information (step S133). The vehicle setting information includes a uniform resource locator (URL) or the like of the map server 40. The service providing apparatus 10 transmits the vehicle setting information to the in-vehicle terminal 30 in accordance with a request from the in-vehicle terminal 30 (step S114).

Next, the in-vehicle terminal 30 requests the service providing apparatus 10 for the access key T, which is capable of unlocking the access lock K (step S134). In response to this request, the service providing apparatus 10 creates the access key T, based on the access lock K created in step S111 (step S115). The service providing apparatus 10 transmits the created access key T to the in-vehicle terminal 30 (step S116).

The map server 40, specifically, the controller 41 included in the map server 40 requests the service providing apparatus 10 for the access lock K (step S141). In response to the request from the map server 40, the service providing apparatus 10 transmits the access lock K created in step S111 to the map server 40 (step S117). The map server 40 holds the received access lock K in a storage unit, not illustrated.

By using the access key T that has been received from the service providing apparatus 10, the in-vehicle terminal 30 accesses the URL of the map server 40 indicated by the vehicle setting information. Then, the in-vehicle terminal 30 requests the map server 40 for map information (step S135). In a case where the access key T and the access lock K held by the map server 40 correspond to each other, that is, in a case where the access key T is capable of unlocking the access lock K, the in-vehicle terminal 30 is permitted to access the resource (the map information) managed by the map server 40. As a result, the map information is distributed (downloaded) from the map server 40 to the in-vehicle terminal 30 (step S142). The in-vehicle terminal 30 updates the map information stored in the storage unit 320 with the map information that has been distributed from the map server 40 (step S136).

In this manner, by distributing the access lock K to the map server 40 and distributing the access key T corresponding to the access lock K to the in-vehicle terminal 30, it becomes possible to appropriately distribute the map information from the map server 40 to the vehicle V1 without the intervention of the service providing apparatus 10. In addition, by registering the vehicle ID of the registered vehicle in the authentication DB of the vehicle authentication server 50 beforehand, it becomes possible to restrict access to the map server 40 from vehicles other than the registered vehicle, so that a map update service that ensures security can be provided.

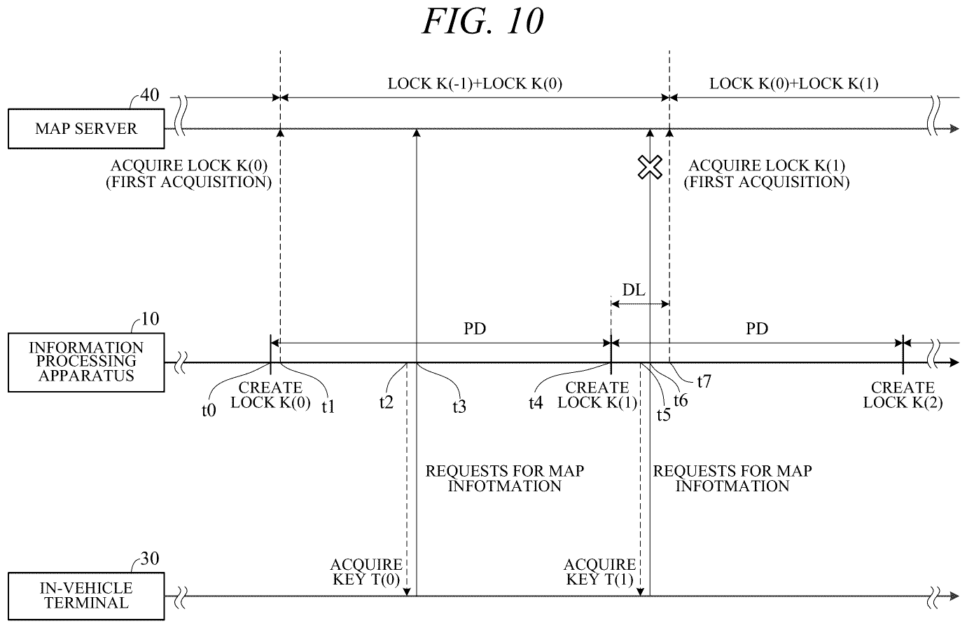

Meanwhile, the access lock K, which is created by the service providing apparatus 10, is updated in every predetermined period PD as described above. On the other hand, the access lock K is acquired by the map server 40 in every predetermined time PT1 (<PD). FIG. 10 is a diagram for describing an update timing of the access lock K in the service providing apparatus 10 and an acquisition timing of the access lock K in the map server 40.

A lock K(0) is created by the service providing apparatus 10 at time t0, and then in the request for the access lock, which is performed first in the map server 40, the lock K(0) is distributed from the service providing apparatus 10 to the map server 40 (time t1). The map server 40 holds the lock K(0) that has been received. Note that the map server 40 does not discard a previous lock (lock K(−1)) even when the map server 40 receives the lock K(0), and continuously holds the previous lock until the map server 40 acquires a next lock (lock K(1)). When receiving the ACC-ON operation by the driver, the in-vehicle terminal 30 requests the service providing apparatus 10 for an access key, and acquires the access key (time t2). In this situation, in a case where the in-vehicle terminal 30 does not hold a valid authentication token, the vehicle authentication (steps S132, S112, S151, and S113 in FIG. 9) is conducted.

When accepting the request for the access key at time t2, the service providing apparatus 10 creates an access key T(0), which is capable of unlocking the lock K(0), and transmits the access key T(0) to the in-vehicle terminal 30. The in-vehicle terminal 30 requests the map server 40 for the map information using the acquired key T(0) (time t3). The key T(0) is an access key corresponding to the lock K(0) held by the map server 40, and the access by the in-vehicle terminal 30 to the map server 40 is permitted. As a result, the map information is distributed (downloaded) from the map server 40 to the in-vehicle terminal 30.

When the predetermined period PD elapses from the time t0, the service providing apparatus 10 updates the access lock (time t4). Specifically, the lock K(1) is created. Note that the map server 40 acquires the access lock in every predetermined time PT1, and a period of time (hereinafter, referred to as a delay period) DL from the time when the service providing apparatus 10 creates the access lock to the time when the map server 40 first acquires the access lock has the length of time PT1 at the maximum. In a case where there is a request for an access key from the in-vehicle terminal 30 within such a delay period DL, the access key distributed from the service providing apparatus 10 to the in-vehicle terminal 30 in response to the request does not correspond to the access lock held by the map server 40.

Specifically, when receiving the request for the access key from the in-vehicle terminal 30 in the delay period DL (time t4 to t7) after the lock K(1) is created, the service providing apparatus 10 creates a key T(1), which is capable of unlocking the lock K(1), and transmits the key T(1) to the in-vehicle terminal 30 (time t5). By using the key T(1), the in-vehicle terminal 30 requests the map server 40 for the map information (time t6). However, the map server 40 has not yet acquired the lock K(1) corresponding to the key T(1) from the service providing apparatus 10. Therefore, the in-vehicle terminal 30 is not capable of obtaining authentication from the map server 40, and is not capable of downloading the map information.

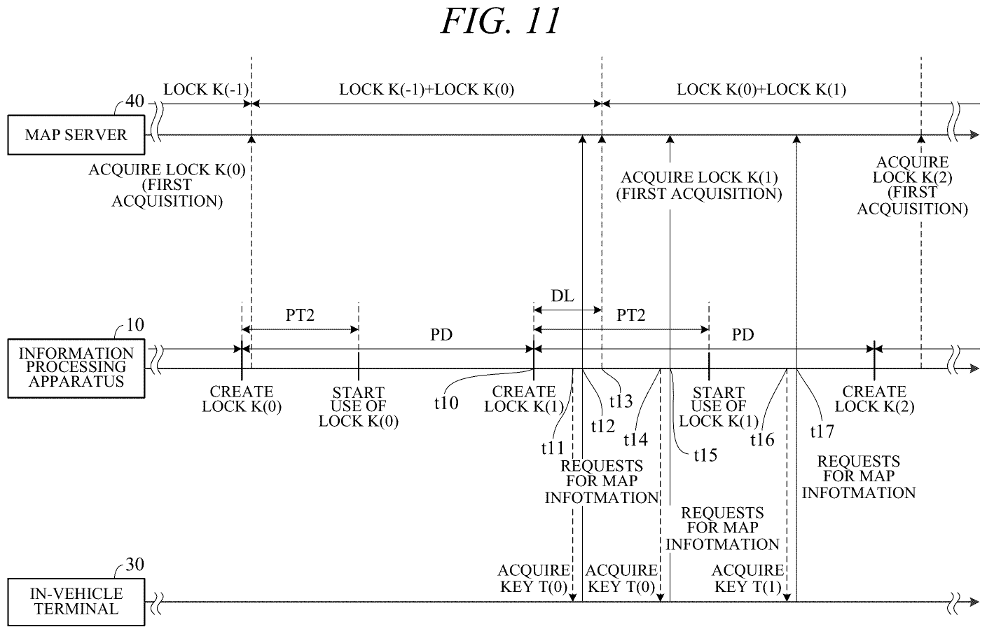

Hence, the service providing apparatus 10 is configured not to use the access lock after update, until a predetermined time PT2 (>PT1) elapses since the access lock is updated. FIG. 11 is a diagram for describing a use start timing of the access lock.

As illustrated in FIG. 11, after the service providing apparatus 10 creates the lock K(1) at time t10, when receiving a request for an access key from the in-vehicle terminal 30 (time t11) before a predetermined time PT2 elapses, the service providing apparatus 10 creates a key T(0) corresponding to a previous lock (the lock K(0)). Then, the service providing apparatus 10 distributes the key T(0) to the in-vehicle terminal 30. By using the key T(0) that has been distributed from the service providing apparatus 10, the in-vehicle terminal 30 requests the map server 40 for the map information (time t12). The map server 40 holds the lock K(0) corresponding to the key T(0). Therefore, access by the in-vehicle terminal 30 to the map server 40 is permitted, and the map information is distributed to the in-vehicle terminal 30. In addition, also after acquiring the lock K(1) with the first request for the access lock (time t13) after time t10, the map server 40 continuously holds the lock K(0) before update. Therefore, also after the time t13, by using the key T(0), the in-vehicle terminal 30 is capable of acquiring the map information from the map server 40 (time t14 and time t15).

When the predetermined time PT2 elapses (time t15) since the lock K(1) is created at time t10, the service providing apparatus 10 starts using the lock K(1). Then, when receiving a request for an access key from the in-vehicle terminal 30 (time t16), the service providing apparatus 10 creates a key T(1), which is capable of unlocking the lock K(1). Then, the key T(1) is distributed to the in-vehicle terminal 30. The map server 40 already holds the lock K(1) corresponding to the key T(1), and thus by using the key T(1), which has been distributed from the service providing apparatus 10, the in-vehicle terminal 30 is capable of acquiring the map information from the map server 40 (time t17).

According to embodiments of the present invention, the following operation and effect are achievable.
(1) A data update method for distributing update data from the map server 40 as a data distribution apparatus to a plurality of vehicles V1, the data update method including: a creation step of creating, by the service providing apparatus 10 as a management server, a single access lock valid for a predetermined period and an access key capable of unlocking the access lock (steps S111 and S115 in FIG. 9); a lock transmission step of transmitting, by the service providing apparatus 10, the access lock to the map server 40 (step S117 in FIG. 9); a key transmission step of transmitting, by the service providing apparatus 10, the access key to each of the in-vehicle terminals 30 of the plurality of vehicles V1, which is communicably connected with the service providing apparatus 10 (step S116 in FIG. 9); a request step of making a distribution request, by the in-vehicle terminal 30, that the map server 40 distribute the update data, by using the access key (step S135 in FIG. 9); and a distribution step of determining, by the map server 40, whether the access key used for the distribution request is capable of unlocking the access lock, and when determining that the access key is capable of unlocking the access lock, distributing the update data to the in-vehicle terminal 30 in response to the distribution request (step S142 in FIG. 9). Accordingly, the data distribution apparatus is capable of accurately authenticating the in-vehicle terminal without the intervention of a management server. As a result, the authentication that achieves both security and convenience is enabled.
(2) In the lock transmission step, the service providing apparatus 10 transmits, to the map server 40, the validity period information indicating a predetermined period together with the access lock. In the distribution step, the map server 40 uses the access lock that has been transmitted from the service providing apparatus 10 in the lock transmission step within the predetermined period indicated by the validity period information. This enables the validity period of the access lock to be shared between the management server and the data distribution apparatus. As a result, it becomes possible to suppress a mismatch between the access lock that has been distributed to the data distribution apparatus and the access key that has been distributed to the in-vehicle device.
(3) In the key transmission step, the service providing apparatus 10 does not transmit the access key that has been created in the creation step to the in-vehicle terminal 30, until a certain period of time elapses after the creation. Accordingly, it becomes possible to prevent the in-vehicle terminal from using the access key, before the access lock becomes available by the data distribution apparatus.
(4) In the request step, the update data requested to be distributed by the in-vehicle terminal 30 is map information (hereinafter, also referred to as map data) corresponding to a traveling area of the vehicle V1 on which the in-vehicle terminal 30 is mounted. This enables the authentication that achieves both security and convenience also in a service having a high frequency of data update, such as a map data update service for connected cars.
(5) The map update system 2 as a data update system distributes the update data from the map server 40 to the plurality of vehicles V1. The service providing apparatus 10, the in-vehicle terminal 30, which is mounted on each of a plurality of vehicles V1, and the map server 40 are provided. The service providing apparatus 10 includes the authentication unit 114, which creates a single access lock valid for a predetermined period and an access key capable of unlocking the access lock, which transmits the access lock to the map server 40, and which further transmits the access key to each of the in-vehicle terminals 30 of the plurality of vehicles V1, which are communicably connected with the service providing apparatus 10. The in-vehicle terminal 30, specifically, a request unit as a functional configuration included in the processing unit 310 of the in-vehicle terminal 30 requests the map server 40 to distribute the update data, by using the access key. The map server 40, specifically, a distribution unit as a functional configuration included in the processing unit of the map server 40 determines whether the access key used in the distribution request is capable of unlocking the access lock, and when determining that the access key is capable of unlocking the access lock, distributes the update data to the in-vehicle terminal in response to the distribution request.

In the above embodiment, in the creation step, the service providing apparatus 10 creates the access lock and the access key corresponding to the access lock. However, the service providing apparatus 10 may newly create only an access lock, may transmit the access lock to the map server 40, and may cause the map server 40 to end the distribution of the update data. That is, the data update method may further include a distribution end step of newly creating only the access lock, and transmitting the access lock to the data distribution apparatus, when the management server causes the data distribution apparatus to end the distribution of the update data. Alternatively, the service providing apparatus 10 may newly create only an access key, may distribute the access key to each of the in-vehicle terminals 30 of the plurality of vehicles V1, and may cause the map server 40 to end the distribution of the update data. That is, the data update method may further include a distribution end step of newly creating only the access key, and transmitting the access key to each of the in-vehicle terminals of the plurality of vehicles, when the management server causes the data distribution apparatus to end the distribution of the update data. Accordingly, for example, when intending to stop the data distribution due to a reason that an error is found in the distribution data or the like, it becomes possible to easily stop the data distribution only by the control by the management server.

In addition, in the above-described embodiment, description has been made with regard to an example of a case in which the processing unit 110 of the service providing apparatus 10 includes, as the functional configurations, the instruction reception unit 111, the determination unit 112, the instruction management unit 113, and the authentication unit 114. However, in the service providing apparatus 10 included in the map update system 2, the processing unit 110 may include only the authentication unit 114 as a functional configuration.

The above embodiment can be combined as desired with one or more of the above modifications. The modifications can also be combined with one another.

According to the present invention, it becomes possible to provide data update that achieves both security and convenience.

Above, while the present invention has been described with reference to the preferred embodiments thereof, it will be understood, by those skilled in the art, that various changes and modifications may be made thereto without departing from the scope of the appended claims.

What is claimed is:

1. A service providing apparatus comprising
a microprocessor and a memory coupled to the microprocessor, wherein
the microprocessor is configured to perform:
receiving operation instruction information transmitted from a user terminal and including an instruction of a remote operation for a vehicle on which an in-vehicle terminal is mounted;
determining a validity period of the instruction of the remote operation, based on a type of the instruction included in the operation instruction information; and
transmitting vehicle instruction information including the operation instruction information and validity period information indicating the validity period to the in-vehicle terminal,
the memory is configured to store processing state information indicating a progress situation of processing performed by the in-vehicle terminal, based on the vehicle instruction information, and
the microprocessor is configured to further perform
unless processing result information indicating a result of the processing performed based on the vehicle instruction information from the in-vehicle terminal within the instruction validity period is received, updating the processing state information stored in the memory to information indicating that performing the processing is stopped.

2. The service providing apparatus according to claim 1, wherein
the validity period is a first validity period,
the microprocessor is configured to further perform generating an access lock to which a second validity period is set and an access key capable of unlocking the access lock, the access lock and the access key being used in an authentication process of the in-vehicle terminal, and
the microprocessor is configured to perform the determining including determining the first validity period not to exceed the second validity period.

3. The service providing apparatus according to claim 1, wherein
the microprocessor is configured to perform
the updating including, when receiving the operation instruction information including the instruction of the remote operation, updating the processing state information to information indicating that the processing is being performed,
after transmitting the vehicle instruction information including the operation instruction information to the in-vehicle terminal, upon receipt of the processing result information from the in-vehicle terminal within the instruction validity period, updating the processing state information with the processing result information, whereas when not receiving the processing result information from the in-vehicle terminal within the instruction validity period, updating the processing state information with information indicating that performing the processing is stopped.

4. The service providing apparatus according to claim 1, wherein
the memory stores the validity period information corresponding to each of a plurality of instructions of remote operations of different types,
the microprocessor is configured to perform
the determining including reading, based on a type of an instruction of the remote operation included in the operation instruction information received from the user terminal, the validity period information corresponding to the instruction of the remote operation from the memory, and
the transmitting including transmitting, to the in-vehicle terminal, the vehicle instruction information including the operation instruction information and the validity period information read from the memory.

5. The service providing apparatus according to claim 1, wherein
the microprocessor is configured to perform
the transmitting including transmitting, when the operation instruction information includes a series of remote operation instructions in which performing order is defined, the vehicle instruction information including the series of remote operation instructions, and
further transmitting, when the processing result information received from the in-vehicle terminal indicates failure of processing corresponding to an instruction among the series of remote operation instructions, a cancel command corresponding to a control command subsequent to the instruction.

6. The service providing apparatus according to claim 1, wherein
the operation instruction information includes an instruction of the remote operation to open or close a door of the vehicle, and the processing performed in the in-vehicle terminal includes controlling a door actuator for opening or closing the door.

7. The service providing apparatus according to claim 1, wherein
the operation instruction information includes an instruction of the remote operation to open or close a window of the vehicle, and the processing performed in the in-vehicle terminal includes controlling a window actuator for opening or closing the window.

8. The service providing apparatus according to claim 1, wherein
the operation instruction information includes an instruction of the remote operation to unlock or lock a door lock of the vehicle, and
the processing performed in the in-vehicle terminal includes controlling a door lock actuator for unlocking or locking the door lock.

9. The service providing apparatus according to claim 1, wherein
the operation instruction information includes an instruction of the remote operation to start engine of the vehicle, and
the processing performed in the in-vehicle terminal includes transmitting a start signal to an engine start device of the vehicle.

10. The service providing apparatus according to claim 1, wherein
the operation instruction information includes an instruction of the remote operation to turn ON or OFF an air conditioner of the vehicle, and the processing performed in the in-vehicle terminal includes transmitting an ON/OFF signal to the air conditioner.
